(19) United States
(12) Patent Application Publication
(10) Pub. No.: US 2014/0036199 A1
(43) Pub. Date: Feb. 6, 2014

(54) DISPLAY DEVICE

(71) Applicants: Shisei Ka, Tokyo (JP); Shinichi Hara, Tokyo (JP)

(72) Inventors: Shisei Ka, Tokyo (JP); Shinichi Hara, Tokyo (JP)

(21) Appl. No.: 14/110,684

(22) PCT Filed: Apr. 15, 2011
(86) PCT No.: PCT/JP2011/059398

§ 371 Date: Oct. 8, 2013

(51) Int. Cl. H04N 5/645

(52) U.S. Cl. CPC H04N 5/645
USPC 349/58; 29/428

(57) ABSTRACT

A display device includes a display panel and a stand, the display device further includes including a cable, a support member which is attached to the stand so as to support at least the lower side of the display panel; and a first fixed member which is located in the support member. The cable is extended from the support member and is connected to the display panel with one end thereof, and connected to the first fixed member with another end thereof.

### TECHNICAL FIELD

The present invention relates to a display device using an LCD.

### BACKGROUND ART

Display devices having display panels, configured of a flat-panel LCD, and stands for supporting display panels are known (e.g. see Patent Literatures 1-3). In this type of display devices exhibiting a structure in which a display panel is supported using a stand via plastic (a resin material) alone, oil components adhered to plastic may cause chemical attack. In this case, it is impossible to maintain a holding structure of a display panel, and therefore a display panel or an overall display unit including a cover member (housing) keeping a display panel may be fallen off from a stand and damaged.

For this reason, conventional display devices employ a structure for supporting a display panel at a stand via a metal chassis.

### CITATION LIST

### Patent Literature

Patent Literature 1: Japanese Utility Model Registration No. 3146674
Patent Literature 2: Japanese Patent Application Publication No. 2006-313220
Patent Literature 3: Japanese Patent Application Publication No. 2011-027871

### SUMMARY OF INVENTION

### Technical Problem

However, conventional display devices, which are each designed to support a display panel at a stand via a metal chassis, may face a difficulty in achieving a further thinned structure (or miniaturization).

Additionally, it is necessary for this type of display devices to further reduce manufacturing costs.

The present invention is made in consideration of the aforementioned circumstances, wherein it is an object of the invention to provide a display device which is designed to stably support a display panel at a stand, which can be further thinned in shape, and which can reduce manufacturing cost.

### Solution to Problem

To achieve the above object, the present invention offers the following means.

The present invention is directed to display device having a display panel and a stand, wherein the display device further includes a metal support member which is attached to the stand so as to support at least the lower part of the display panel, a metal cable which is extended from the support member and connected to the display panel with one end thereof, and a first screw member which has a hole for inserting another end of the metal cable therein and which is screwed into the support member while the metal cable is being wound around the peripheral face.

### Advantageous Effects of Invention

In a display device of the present invention, it is possible to stably support a display panel at a stand, it is possible to achieve a further thinned structure, and it is possible to reduce manufacturing cost.

### BRIEF DESCRIPTION OF DRAWINGS

FIG. 1 (a) A side view and (b) a rear view for illustrating the essential structure of a display device according to a first embodiment of the present invention.

FIG. 2 (a) A side view exhibiting a preliminary state before mounting (or after demounting) a cover member and (b) a side view mounting a cover member in the display device of FIG. 1.

FIG. 3 (a) An illustration in view of a perpendicular direction in an axial direction and (b) an illustration showing a screw head in an axial direction with respect to a second screw member connecting one end of a metal cable to a display panel in the display device of FIG. 1.

FIG. 4 (a) An illustration in view of a perpendicular direction in an axial direction and (b) an illustration showing a screw head in an axial direction with respect to a first screw member connecting the opposite end of a metal cable to a support member in the display device of FIG. 1.

FIG. 5 An illustration of a metal cable in the display device of FIG. 1.

FIG. 6 Illustrations for explaining the procedure of wiring a metal cable between the first and second screw members in the display device of FIG. 1.

FIG. 7 (a) A side view, (b) a top view, and (c) a rear view showing a support member in the display device of FIG. 1.

FIG. 8 (a) A side view and (b) a rear view for illustrating the essential structure of a display device according to a second embodiment of the present invention.

FIG. 9 A front view of the display device of FIG. 8.

FIG. 10 (a) A side view showing a preliminary state before mounting (or after demounting) a cover member and (b) a side view showing a state mounting a cover member in the display device of FIG. 8.

FIG. 11 Perspective views showing a metal hook member in the display device of FIG. 8.

FIG. 12 Illustrations for explaining the procedure of wiring a metal cable between the first screw member and the metal hook member in the display device of FIG. 8.

### DESCRIPTION OF EMBODIMENTS

### First Embodiment

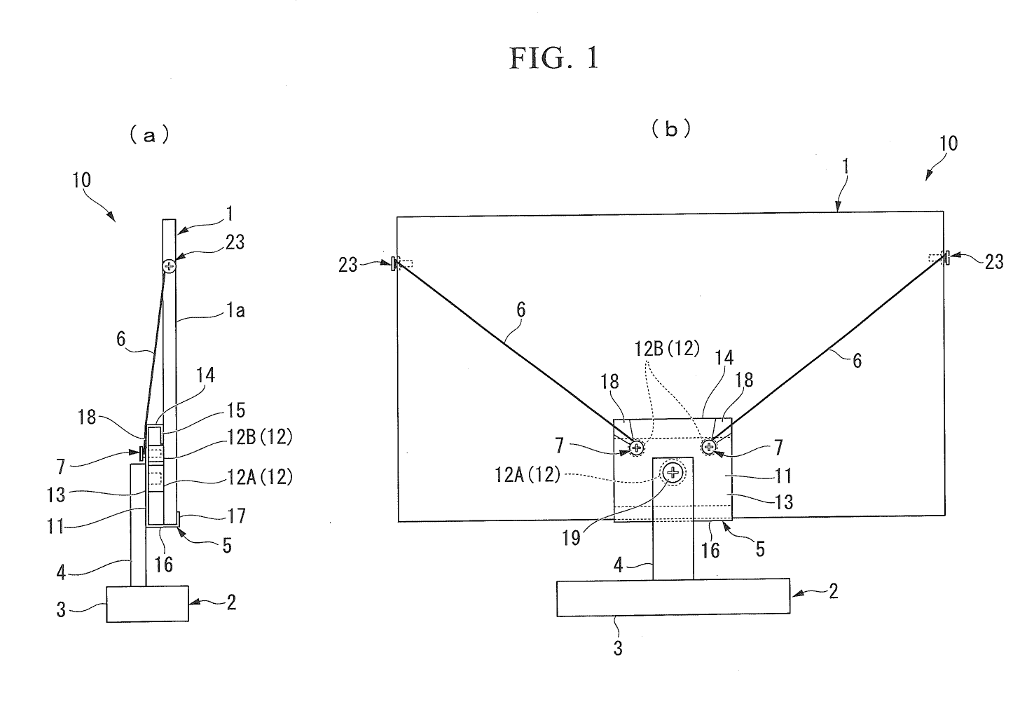

Hereinafter, a display device 10 according to a first embodiment of the present invention will be described with reference to FIGS. 1 to 7.

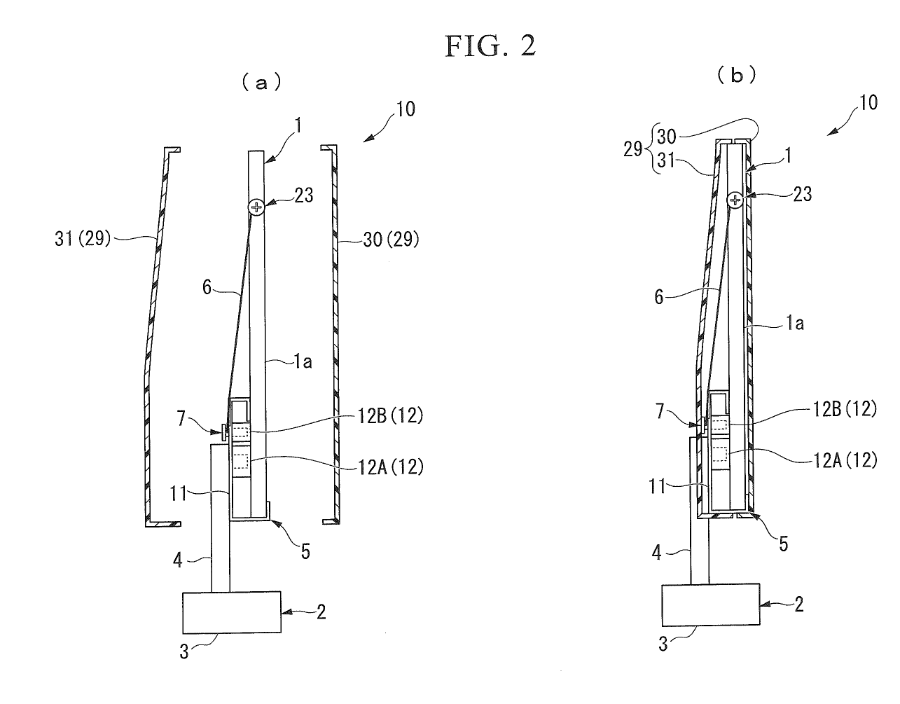

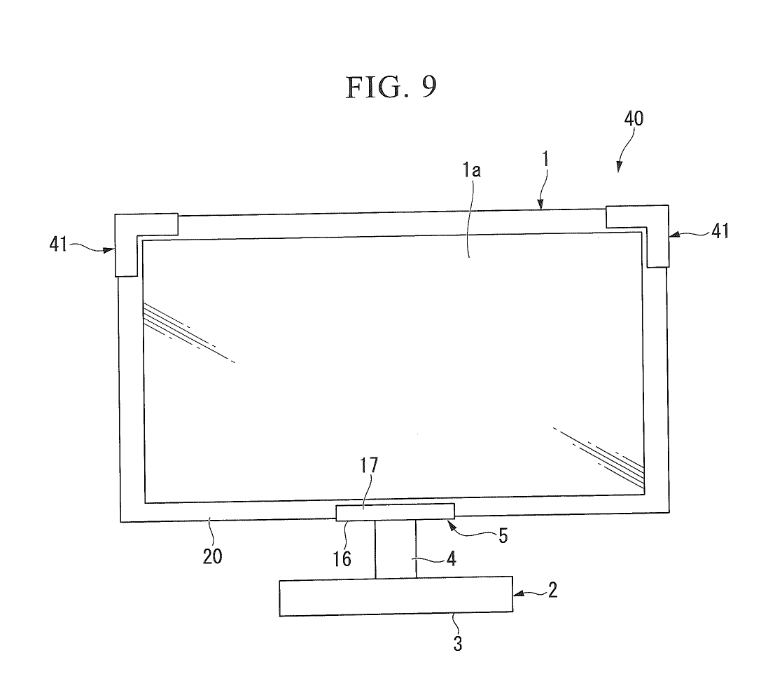

The display device 10 of the present embodiment is a flat-panel monitor, a display, or a television, as shown in FIGS. 1 and 2, which includes a display panel 1, configured of a flat-panel LCD, and a stand 2 for supporting the display panel 1. The display panel 1 having a rectangular shape displays images such as characters, figures, still pictures, and moving pictures on one surface (i.e. a face directed rightwards in FIG. 1(a)) 1a among external surfaces directed in the thickness direction. In the present embodiment, the thickness direction of the display panel 1 is disposed in a horizontal direction, while the surface la has a rectangular shape with a long side disposed in a horizontal direction perpendicular to the thickness direction and a short side disposed in a vertical direction perpendicular to the thickness direction (see FIG. 9).

In the following description, a width direction refers to the horizontal direction perpendicular to the thickness direction of the display panel 1, while a height direction refers to the vertical direction perpendicular to the thickness direction of the display panel 1. In the thickness direction of the display panel 1, a front side refers to a direction of the surface 1a while a rear side refers to a direction opposite to the direction of the surface 1a.

In FIG. 1(a) (b), a pair of internal-thread holes is formed at a pair of side faces which are positioned at the opposite ends of the display panel 1 in the width direction and which are disposed in the width direction. The internal-thread holes are formed at the upper ends of the side faces of the display panel 1 so that they can be engaged with second screw member 23 which will be discussed later.

Additionally, the stand 2 includes a pedestal 3 mounted on a floor or a base for setting up the display device 10, and a shaft 4 which is supported by the pedestal 3 and extended upwards.

The display device 10 includes a metal support member 5, which is arranged in the stand 2 and which supports at least the lower part of the display panel 1, a metal cable 6, which is connected to the display panel 1 with one end thereof, and a hole 8 allowing for insertion of the opposite end of the metal cable 6, as well as first screw members 7 each of which are formed to wind the metal cable 6 around a peripheral face 9 and each of which is engaged with the support member 5. Additionally, the display device 10 includes second screw members 23, with holes 24 allowing for insertion of one end of the metal cable 6, each of which is formed to wind the metal cable 6 around a peripheral face 25 and which are engaged with the internal-thread holes of the display panel 1.

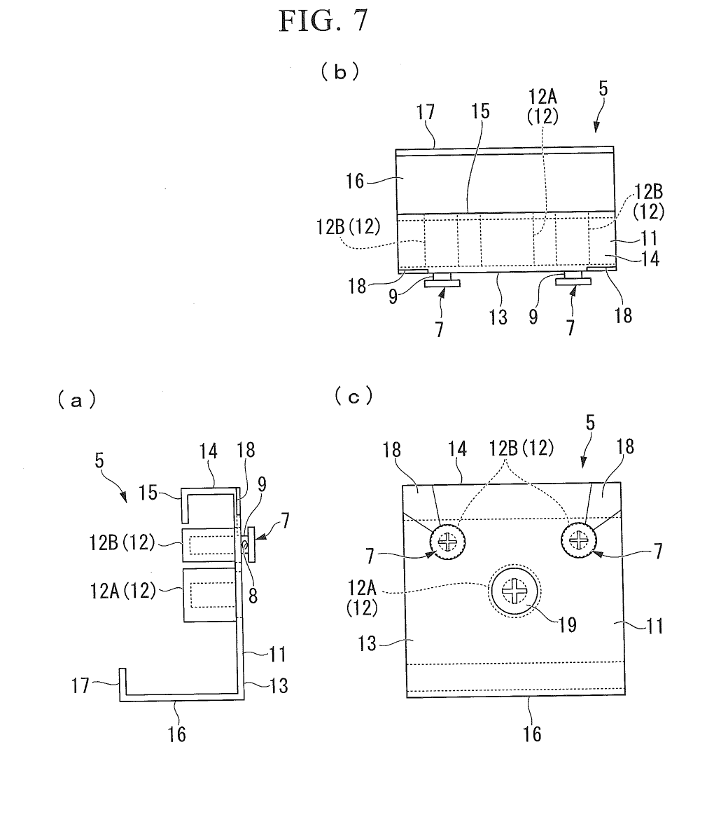

As shown in FIGS. 1 and 7, the support member 5 includes a plate member 11 having a C-shaped cross section and a plurality of screw taps 12 formed in the plate member 11.

In FIGS. 1(a) (b), the plate member 11 includes a main body 13, having a rectangular disk shape, which is attached to the upper end of the shaft 4 of the stand 2 and which is expanded in the width direction (i.e. the left-right direction in FIG. 1(b)) and the height direction (i.e. the top-down direction in FIG. 1(b)), a top wall 14 which is disposed in the front direction (i.e. the right side in FIG. 1(a)) from the upper end of the main body 13, and an upper-front portion 15 which is folded back downwardly from the edge of the top wall 14 opposite to the main body 13. Additionally, the plate member 11 includes a bottom wall 16 disposed in the front direction from the lower end of the main body 13, and a lower-front portion 17 which is folded back in the upper direction from the edge of the bottom wall 16 opposite to the main body 13.

A projecting size of the bottom wall 16 projecting from the main body 13 in the front direction is larger than a projecting size of the top wall 14 projecting from the main body 13 in the front direction. The upper face of the bottom wall 16 comes in contact with the lower face of the display panel 1, and therefore the bottom wall 16 supports the lower side of the display panel 1. Additionally, a face of the lower-front portion 17 facing the main body 13 (or a face directing rearwards) comes in contact with an external frame 20 (see FIG. 9) of the surface 1a of the display panel 1, and therefore the lower-front portion 17 supports the front side of the display panel 1.

In FIG. 7(a) (b) (c), a hole running through the main body 13 in the thickness direction (i.e. the left-right direction in FIG. 7(a)) is formed at the center position in the width direction (i.e. the left-right direction in FIG. 7(c)) and the height direction (i.e. the upper-lower direction in FIG. 7(c)) of the main body 13, wherein a stand screw tap 12A for fixing the support member 5 at the stand 2 among a plurality of screw taps 12 is formed in correspondence with the hole. Additionally, a pair of holes, running through the main body 13 in the thickness direction, which are distanced from each other in the width direction is formed above the stand screw tap 12A in the main body 13, wherein a pair of cable screw taps 12B for connecting the metal cable 6 to the support member 5 among a plurality of screw taps 12 is formed in correspondence with the holes. A stand screw 19, which will be discussed later, is screwed into the internal-thread hole of the stand screw tap 12A. Additionally, the first screw members 7 are detachably screwed into the internal-thread holes of the cable screw taps 12B.

In FIG. 1(a), the screw taps 12 are arranged in the surface (i.e. the surface in the front direction) directing to the display panel 1 of the main body 13 (i.e. the right side of FIG. 1(a)). The internal-thread holes of the screw taps 12, running through the holes of the main body 13, are opened in the rear direction (i.e. the left side of FIG. 1(a)). The terminal faces of the screw taps 12 in the front direction and the front face of the upper-front portion 15 are each placed at substantially the same position in the thickness direction and come into contact with the other surface (i.e. the left side of FIG. 1(a)) directing to the main body 13 of the display panel 1, and therefore the screw taps 12 an the upper-front portion 15 support the rear side of the display panel 1.

A hole is formed to run through the upper end of the shaft 4 of the stand 2 in the thickness direction, and therefore the stand screw 19 is screwed into the stand screw tap 12A via the hole. Additionally, the face of the main body 13 (i.e. the face in the rear direction) opposite to the display panel 1 comes in contact with the face directing to the display panel 1 (i.e. the face in the front direction) at the upper end of the shaft 4. The support member 5 is fixed to the upper portion of the stand 2 such that the stand screw 19 is engaged with the stand screw tap 12A via the hole of the shaft 4.

In FIG. 7(c), a pair of cable guide channels 18 is formed at the opposite ends in the upper end of the main body 13 in the width direction. The cable guide channels 18 are extended from the positions of the cable screw taps 12B of the main body 13 to be gradually distanced from each other in the upward direction. Additionally, the width between the cable guide channels 18 is gradually increased as they depart from the cable screw taps 12B.

In FIG. 5, it is possible to appropriately set the diameter (or thickness) of the metal cable 6 in response to the thickness, the weight, and the required fixing strength of the display panel 1, wherein the diameter should preferably set to 0.5 mm or more. The length L of the metal cable 6 may differ depending on the size of the display panel 1, for example, it can be calculated using the following equation.

L=L1+3.5d1+3.5d2

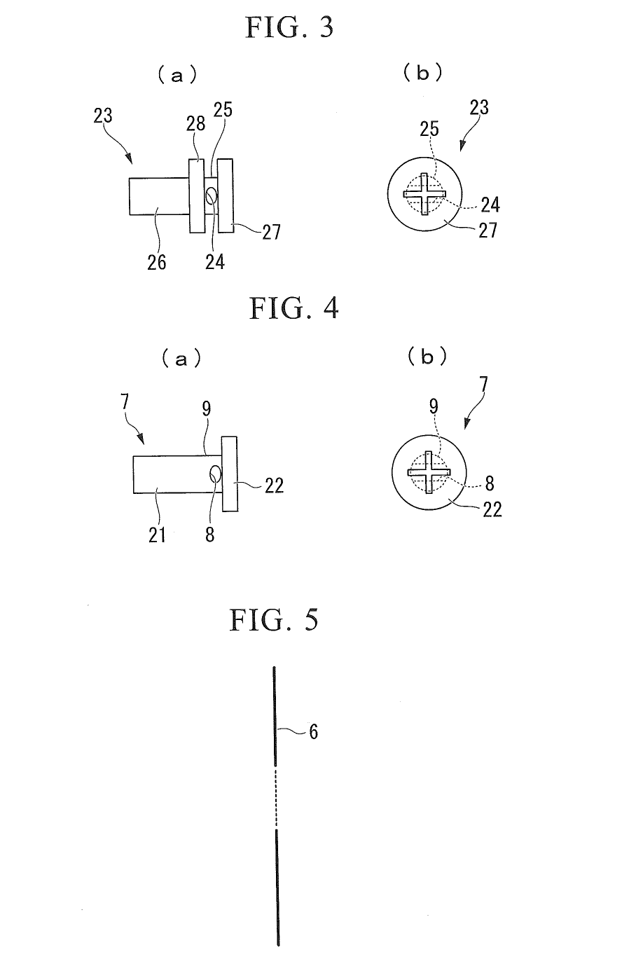

In the above equation, L1 denotes the distance (or the distance between tapped holes) between the hole 8 of the first screw member 7 and the hole 24 of the second screw member 23; d1 denotes the diameter (see FIG. 4) of the first screw member 7 at the peripheral face 9 winding the metal cable 6 therearound; d2 denotes the diameter (see FIG. 3) of the second screw member 23 at the peripheral face 25 winding the metal cable 6 therearound. In the above equation, multipliers “3.5” applied to d1, d2 are reference values which are not restrictive; hence, it is possible to appropriately set multipliers in response to the effective number of turns for completely tightening the first and second screw members 7, 23 into the internal-thread holes (i.e. tightening up to the progressing ends) in consideration of the fixing strength.

In FIG. 4(a) (b), the first screw member 7 having an axial shape includes a thread part 21 formed with an external thread around the peripheral face 9 and a screw head part 22 having a diameter larger than that of the thread part 21. The hole 8 running through the thread part 21 in the diameter direction is formed at the end portion of the thread part 21 proximate to the screw head part 22. The internal diameter of the hole 8 is slightly larger than the diameter of the metal cable 6 and set to a value of the diameter of the metal cable 6 plus 0.1 mm in the present embodiment. The first screw member 7 with one end of the metal cable 6 inserted into the hole 8 is screwed into the cable screw tap 12B of the support member 5; hence, the metal cable 6 is wound around the peripheral face 9 of the first screw member 7 having the opening of the hole 8.

In FIG. 3(a) (b), the second screw member 23 having an axial shape includes a thread part 26 with an external thread formed on the peripheral face and a screw head part 27 with a diameter larger than that of the thread part 26. The hole 24 running through the thread part 26 in the diameter direction is formed at the end portion of the thread part 26 proximity to the screw head part 27. The internal diameter of the hole 24 is slightly larger than the diameter of the metal cable 6 and set to a value of the diameter of the metal cable 6 plus 0.1 mm in the present embodiment. Additionally, a flange 28 having the same diameter as the screw head part 27 is formed at a specific position of the thread part 26 which is opposite to the screw head part 27 via the hole 24 formed at the end portion of the thread part 26 proximate to the screw head part 27. The second screw member 23 with one end of the metal cable 6 inserted into the hole 24 is screwed into the internal-thread hole of the display panel 1, and therefore the metal cable 6 is wound around the peripheral face 25 of the second screw member 23 with the opening of the hole 24 (i.e. the intermediate portion of the peripheral face of the thread part 26 interposed between the screw head part 27 and the flange 28). Thus, one end of the metal cable 6 is connected to the display panel 1 via the second screw member 23.

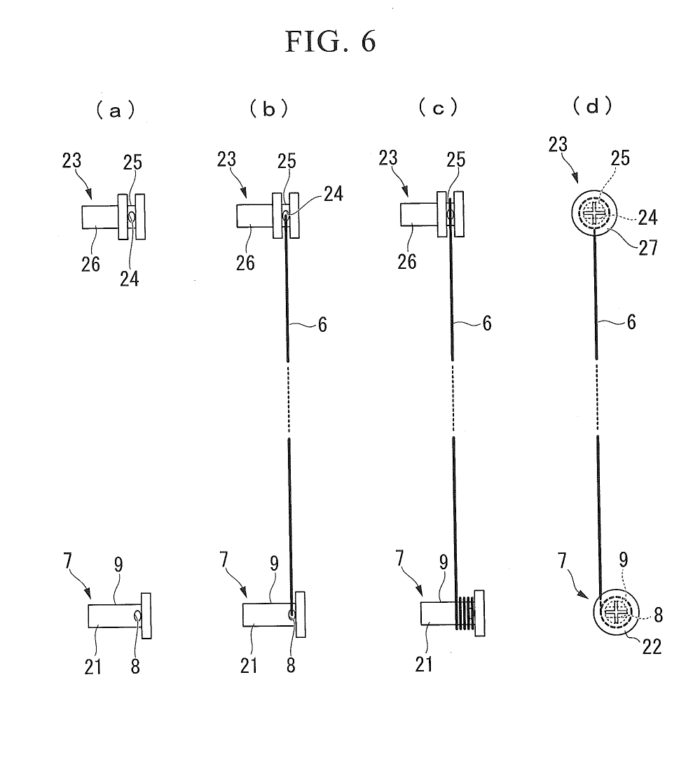

FIG. 6 shows the procedure of attaching the metal cables 6 to the first and second screw members 7 and 23. FIG. 6(a) shows the condition where the distal end of the thread part 21 of the first screw member 7 is screwed into the cable screw tap 12B of the support member 5 while the distal end of the thread part 26 of the second screw member 23 is screwed into the internal-thread hole of the display panel 1. In this condition, as shown in FIG. 6(b), one end of the metal cable 6 (i.e. the upper end in FIG. 6(b)) is inserted into the hole 24 of the second screw member 23 while the other end (i.e. the lower end in FIG. 6(b)) is inserted into the hole 8 of the first screw member 7.

Next, as shown in FIG. 6(c) (d), the second screw member 23 is further tightened while the metal cable 6 is wound around the peripheral face 25 of the thread part 26. Additionally, the first screw member 7 is further tightened while the metal cable 6 is wound around the peripheral face 9 of the thread part 21. It is not necessary to limit the sequence for tightening the first and second screw members 7, 23, but it is possible to achieve good workability by firstly tightening the second screw member 23 positioned above the first screw member 7. It is necessary to adjust the tightening of the first and second screw members 7 and 23 so as not to loose the metal cables 6 while confirming the tension of the metal cables 6.

In the condition where the metal cables 6 are stretched under tension between the first and second screw members 7, 23, as shown in FIG. 1(b), the metal cables 6 are extended such that they are gradually distanced from each other in the width direction as they are extended upwardly above the support member 5 and externally in the width direction of the display panel 1 (i.e. in the upwardly slanted direction). The metal cables 6 regulate the movement of the display panel 1 in the width direction and the upward direction relative to the support member 5. Additionally, the other ends of the metal cables 6, positioned proximate to the first screw members 7, are arranged inside the cable guide channels 18 of the support member 5.

Owing to the aforementioned structure, it is possible to regulate the movement of the display panel 1 in the thickness direction, the width direction, and the height direction of the support member 5. In this connection, the support member 5 is configured to support at least the lower side of the display panel 1. Specifically, it is possible to regulate the movement of the display panel 1 relative to the support member 5 in the thickness direction, for example, by means of another member interposed between the support member 5 and the display panel 1.

As shown in FIG. 2(a) (b), the display device 10 includes a cover member 29 which is arranged to hold the display panel 1 in the thickness direction. The cover member 29 includes a front bezel 30 which is attached to the front side of the display panel 1 in the thickness direction, and a rear cover 31 which is attached to the rear side of the display panel 1 in the thickness direction. In FIG. 2(b) showing the condition where the cover member 29 is attached to the display panel 1, the metal cables 6, the support member 5, the first screws 7, and the second screws 23 are all stored inside the cover member 29.

The display device 10 of the present embodiment as described above is designed such that the metal support member 5 supports at least the lower side of the display panel 1 while the metal cables 6 connect the support member 5 to the display panel 1, thus demonstrating the following effect.

That is, the metal cables 6 regulate the relative movement between the display panel 1 and the support member 5 while the display panel 1 is stably supported above the support member 5. Thus, the display panel 1 and the support member 5 are mutually fixed together; the display panel 1 is stably supported by the stand 2 for a long time; hence, it is possible to prevent the display panel 1 or the overall display unit including the cover member 29 keeping the display panel 1 from being fallen off from the stand 2.

Additionally, the first screw members 7, which connect the metal cables 6 to the support member 5 and which allow for insertion of the other ends of the metal cables 6 into the holes 8, are engaged with the support member 5 such that the metal cables 6 are wound around the peripheral faces 9; hence, it is possible to reliably and easily apply tension to the metal cables 6. Thus, it is possible to prevent the metal cables 6 from being loosen and connected between the display panel 1 and the support member 5; hence, it is possible to reliably produce desired operation and effect via the metal cables 6.

Specifically, it is possible to adjust the fixing strength between the display panel 1 and the support member 5 by adjusting the number of turns for winding the metal cable 6 around the peripheral face 9 of the first screw member 7; hence, it is possible to reliably regulate the relative movement between the display panel 1 and the support member 5. In this connection, it is possible to adjust the fixing strength between the display panel 1 and the support member 5 by adjusting the lengths of the other ends of the metal cables 6 inserted into the holes 8 of the first screw members 7 and then tightening the first screw members 7 via the predetermined number of turns instead of adjusting the number of turns.

According to the structure of the present embodiment, which differs from the conventional art using the metal chassis, it is possible to easily achieve a further thinned structure for the display device 10 because the display device 10 is not bulky (in particular, the exterior thereof is reduced in the thickness direction). Additionally, it is possible to adequately miniaturize the display device 10 because the dimensions of the second screw members 23 projecting in the width direction of the display panel 1 fall within the lengths of the screw head parts 27.

Compared to the conventional art using the metal chassis, the present embodiment can reduce manufacturing cost.

In the present embodiment, the second screw members 23 for connecting the metal cables 6 to the display panel 1 with one ends of the metal cables 6 inserted into the holes 24 are engaged with the display panel 1 such that the metal cables 6 are wound around the peripheral faces 25; hence, similar to the first screw members 7, it is possible to reliably and easily apply tension to the metal cables 6. That is, the present embodiment provides a plurality of adjusting means for adjusting the tension of the metal cables 6 (i.e. the first screw members 7 and the second screw members 23); hence, it is possible to reliably produce desired operation and effect via the metal cables 6.

In this connection, the second screw members 23 are engaged with the internal-thread holes by use of the internal-thread holes which are formed in the display panel 1 in advance; thus, it is possible to simplify the structure which does not need special members for attaching the second screw members 23 to the display panel 1.

Additionally, it is possible to secure the exterior appearance of the display device 10 and to prevent the metal cables 6 from being caught by something during transportation since the metal cables 6 are kept inside the cover member 29 covering the display panel 1.

Moreover, it is possible to prevent the display panel 1 from falling off from the stand 2 because, as described above, the display panel 1 is stably supported by the support member 5 and the metal cables 6 even when the cover member 29 (i.e. the front bezel 30 and the rear cover 31) corrodes due to oil and is then destructed. That is, it is possible to prevent the display panel 1, having a relatively large weight, from falling off from the stand 2, and therefore it is possible to sufficiently improve the safety of the display device 1.

### Second Embodiment

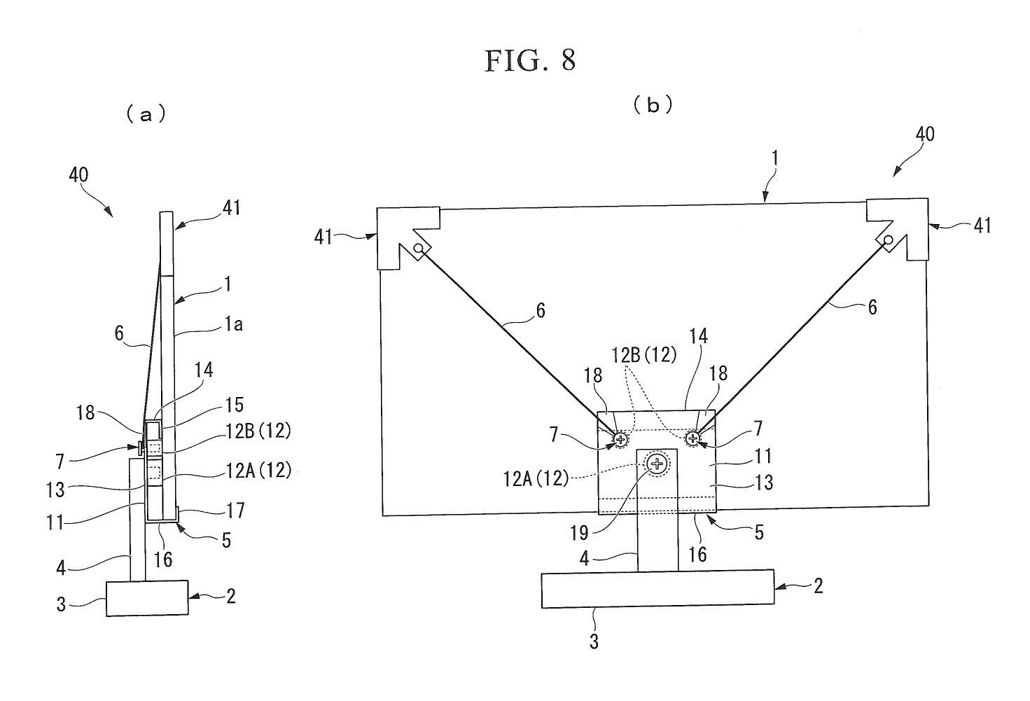

Next, a display device 40 according to a second embodiment of the present invention will be described with reference to FIGS. 8 to 12. Herein, the parts identical to those of the foregoing embodiment are specified using the same reference signs, and therefore descriptions thereof will be omitted.

As shown in FIG. 8(a) (b), the display device 40 of the present embodiment adopts metal hook members 41 instead of the second screw members 23 which are explained in the display device 10. A pair of metal hook members 41 is arranged at the opposite ends of the upper end portion of the display panel 1 in the width direction. One end of the metal cable 6 is connected to the display panel 1 via the metal hook member 41.

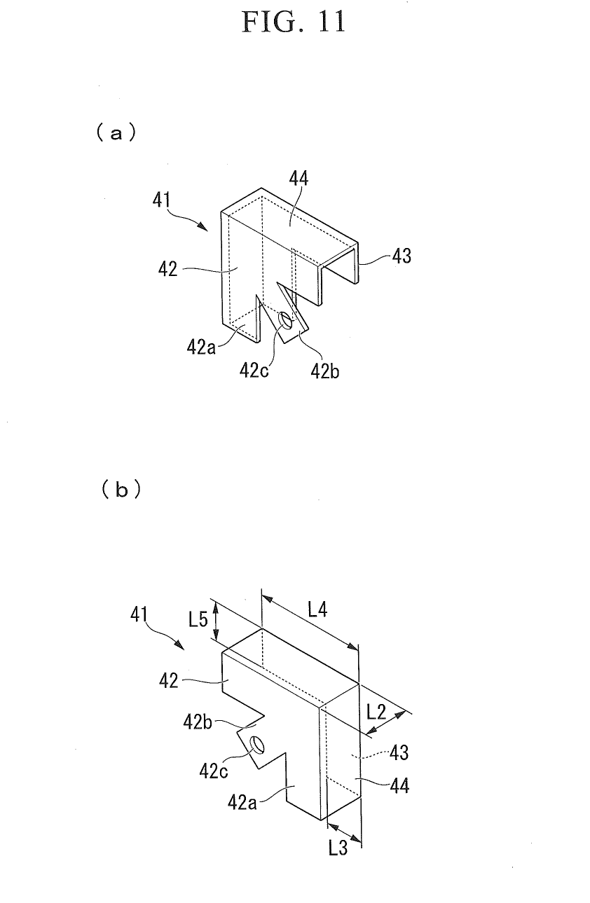

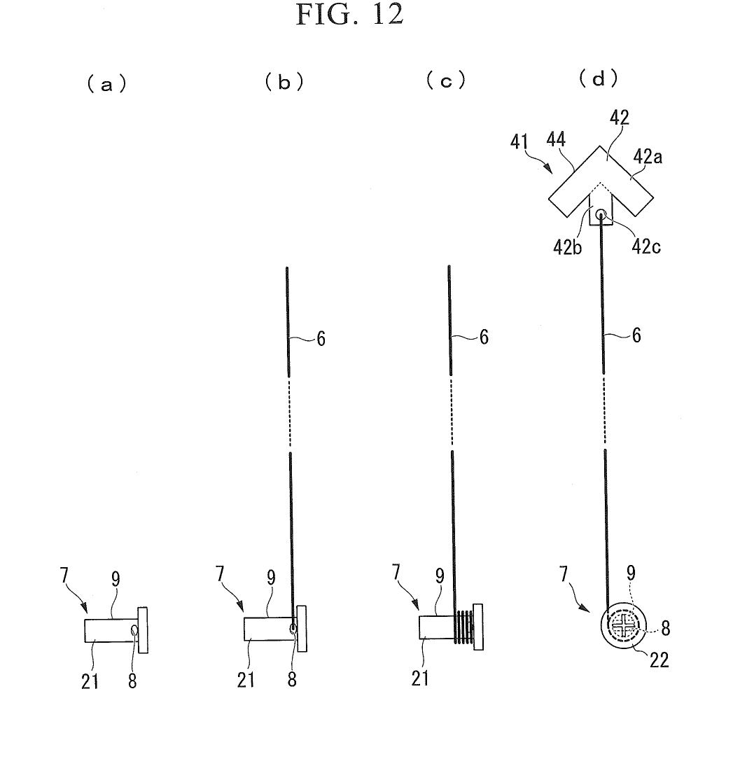

As shown in FIGS. 11(a) (b), the metal hook member 41 includes a rear plate 42 connected to the metal cable 6, a front plate 43 which is disposed oppositely to the rear plate 42 with a specific distance therebetween in the thickness direction, and a peripheral wall 44 connecting between the rear plate 42 and the front plate 43. It is possible to appropriately set the thickness of the metal hook member 41 in response to the required strength, wherein the thickness may preferably range from 0.2 mm to 3 mm.

The rear plate 42 includes a rear plate body 42a having a flat L-shape and an arm 42b extended from the bent portion of the rear plate body 42a. A connection hole 42c running through in the thickness direction is formed in the arm 42b, wherein one end of the metal cable 6 is connected to the connection hole 42c. Specifically, one end of the metal cable 6 is connected to the connection hole 42c, wherein the metal cable 6 is folded back and then fixed to the arm 42b by way of welding. In this connection, the metal cable 6 may be fixed to the arm 42b by way of press work instead of welding.

The front plate 43 having a flat L-shape has substantially the same external shape as the rear plate 42 and the rear plate body 42a.

The peripheral wall 44 has an L-shape which is bent at a rectangle angle so as to connect the edge of the rear plate 42 outwardly positioned in the width direction and the edge of the front plate 43 outwardly positioned in the width direction and to connect the upper end of the rear plate 42 and the upper end of the front plate 43.

In FIG. 11(b), an external dimension L2 of the metal hook member 41 in the thickness is set to the sum of the thickness dimension of the display panel 1, the thickness of the rear plate 42, and the thickness of the front plate 43 plus 0.1 mm. Additionally, a width L3 of a band-shaped portion of the front plate 43 outwardly positioned in the width direction and extended in the height direction is set such that the band-shaped portion may be retracted from the frame edge of the front bezel 30 by −0.2 mm (such that the band-shaped portion will not overlap with the panel screen on the surface 1a of the display panel 1). An external dimension L4 of the metal hook member 41 in the width direction is normally set to 3.5 times the width L3. No illustration is provided, but the external dimension of the metal hook member 41 in the height direction is set identical to the external dimension L4. Moreover, a height L5 of a band-shaped portion, which is disposed on the upper end of the front plate 43 and which is extended in the width direction, is set such that the band-shaped portion may be retracted from the frame edge of the front bezel 30 by −0.2 mm (such that the band-shaped portion will not overlap with the panel screen on the surface 1a of the display panel 1).

FIG. 12 shows the procedure of attaching the metal cable 6 unified with the metal hook member 41 to the first screw member 7. In this connection, FIG. 12(a) (b) (c) omits the illustration of the metal hook member 41. FIG. 12(a) shows the condition where the distal end of the thread part 21 of the first screw member 7 is screwed into the cable screw tap 12B of the support member 5. The metal hook member 41 in which one end of the metal cable 6 is fixed to the rear plate 42 by way of welding or press work in advance is attached to the outside of the upper end of the display panel 1 in the width direction (see FIG. 8(b)). In this condition, the interior face of the peripheral wall 44 of the metal hook member 41 (i.e. the face inwardly directed in the width direction, and the face directed downwardly) comes in contact with the side face and the upper face of the display panel 1. Additionally, the interior face of the rear plate 42 of the metal hook member 41 (i.e. the face directed in the front direction) comes in contact with the other face of the display panel 1 (i.e. the face directed in the rear direction). Moreover, the interior face of the front plate 43 of the metal hook member 41 (i.e. the face directed in the rear direction) comes in contact with the surface 1a of the display panel 1. In this condition, as shown in FIG. 12(b), the other end of the metal cable 6 (i.e. the lower end in FIG. 12(b)) is inserted into the hole 8 of the first screw member 7.

Next, as shown in FIG. 12(c) (d), the first screw member 7 is further tightened while the metal cable 9 is being wound around the peripheral face 9 of the thread part 21. It is necessary to adjust the tightening of the first screw member 7 so as not to loose the metal cable 6 while confirming the tension of the metal cable 6.

As shown in FIG. 8(b), in the condition where the metal cable 6 is stretched under tension between the metal hook member 41 and the first screw member 7, a pair of metal cables 6 is extended outwardly to be gradually distanced from each other in the width direction in the higher position from the support member 5.

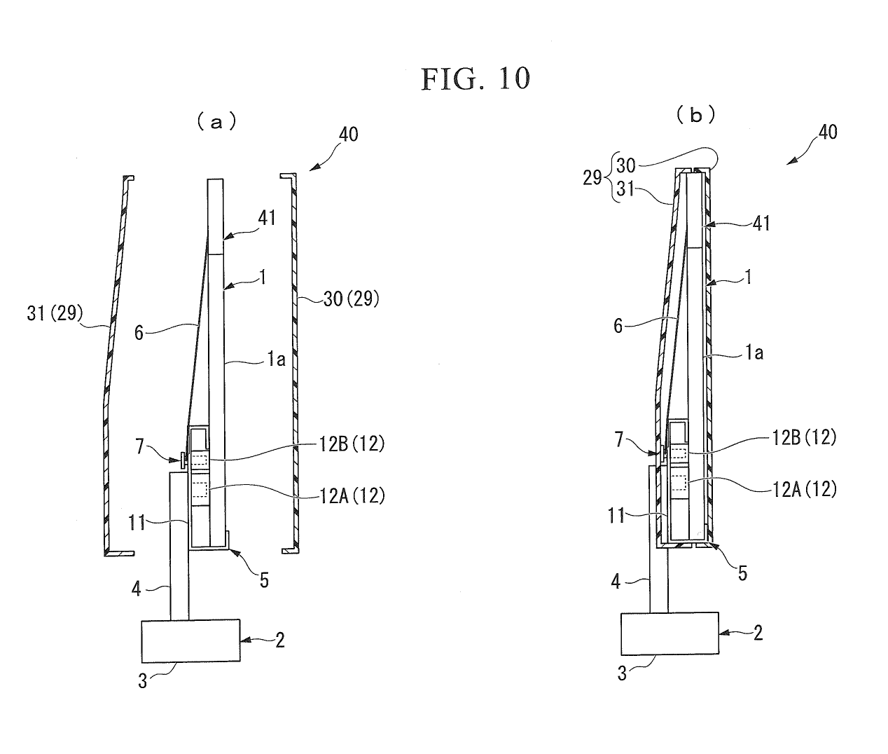

In FIG. 10(b) showing the condition where the cover member 29 is attached to the display panel 1, the metal cables 6, the metal hook members 41, the support member 5, and the first screw members 7 are all kept inside the cover member 29.

The display device 40 of the present embodiment demonstrates the same effect as the display device 10 which is described in the foregoing embodiment. Additionally, the present embodiment is designed to simply attach the metal hook members 41 to the display panel 1 so as to reliably achieve the foregoing operation and effect, created by the metal cables 6, even when the display panel 1 does not allow for the formation of internal-thread holes therein.

Owing to the adaptation of the metal hook members 41 which are projected from the display panel 1 in the thickness direction by a specific size substantially identical to the thickness, it is possible to prevent the display device 40 from being bulky, and it is therefore possible to easily achieve a further thinned structure of the display device 40. Owing to the adaptation of the metal hook members 41 which are projected from the display panel 1 in the width direction and in the height direction by a specific size substantially identical to the thickness, it is possible to sufficiently miniaturize the display device 40.

Compared to the conventional art using the metal chassis, it is possible for the present embodiment to reduce manufacturing cost.

The present invention is not necessarily limited to the foregoing embodiments, which can be further modified in various ways without departing from the essential characteristics of the present invention.

For example, the foregoing embodiments are each designed to use a pair of metal cables 6, but the number of metal cables 6 is not restrictive; hence, it is possible to use a single metal cable, or three or more metal cables.

Additionally, the metal cables 6 need to be extended from the support member 5 such that one ends thereof are connected to the display panel; hence, it is not necessary to limit the constitution in a similar manner to the foregoing embodiments arranging the metal cables 6 extended slantingly and upwardly from the support member 5. Additionally, the connected portions between the metal cables 6 and the display panel 1 are not necessarily limited to the foregoing portions explained in the embodiments.

Moreover, it is possible to appropriately change the shapes of the support member 5, the first and second screw members 7, 23, and the metal hook members 41; hence, the shapes are not necessarily limited to those explained in the foregoing embodiments.

### REFERENCE SIGNS LIST

1 . . . display panel
2 . . . stand
5 . . . support member
6 . . . metal cable
7 . . . first screw member
8 . . . hole
9 . . . peripheral face
10 . . . display device
23 . . . second screw member
29 . . . cover member
41 . . . metal hook member

1. A display device including a display panel and a stand, the display device comprising:
a cable;
a support member which is attached to the stand so as to support at least a lower side of the display panel; and
a first fixed member which is located in the support member,
wherein the cable is extended from the support member, connected to the display panel with one end thereof, and connected to the first fixed member with another end thereof.

2. The display device according to claim 1, wherein said one end of the cable is connected to the display panel via a second fixed member.

3. (canceled)

4. The display device according to claim 1, wherein the cable is kept inside a cover member holding the display panel in a thickness direction.

5. The display device according to claim 1, wherein the first fixed member has a hole for inserting another end of the cable therein, and wherein the fixed member is screwed into the support member while the cable is being wound around a peripheral face.

6. The display device according to claim 1, wherein the cable comprises a metal.

7. An assembling method for a display device including a display panel and a stand, comprising:
arranging a cable;
attaching a support member to the stand so as to support at least a lower side of the display panel;
locating a first fixed member in the support member;
extending the cable from the support member;
connecting the cable to the display panel with one end thereof; and
connecting the cable to the first fixed member with another end thereof.
